(19) United States
(12) Patent Application Publication
(10) Pub. No.: US 2014/0227068 A1
(43) Pub. Date: Aug. 14, 2014

(54) SEED CART TRAILER WITH CONVEYOR TRACK

(71) Applicant: MERIDIAN MANUFACTURING, INC., Strom Lake, IA (US)

(72) Inventors: Juan Neufeld, Winkler (CA); Bernie Thiessen, Winkler (CA)

(73) Assignee: MERIDIAN MANUFACTURING, INC., Storm Lake, IA (US)

(21) Appl. No.: 13/762,786

(22) Filed: Feb. 8, 2013

(51) Int. Cl. B60P 1/36; B65G 65/42; B65G 15/00

(52) U.S. Cl. CPC B60P 1/36; B65G 15/00; B65G 65/425
USPC 414/304; 414/523; 198/861.1

(57) ABSTRACT

A seed cart has a trailer with the hopper cantilevered over the trailer. The trailer includes a track extending along the left and side and rear end. A conveyor is mounted on a carriage for movement along the track, such that the conveyor can extend from the left side of the trailer or from the rear end of the trailer. The conveyor is pivotal for approximately 180°. The conveyor inlet and outlet can be positioned for loading and unloading the hopper, and can be spaced from the hopper for loading and unloading two separate containers.

### BACKGROUND OF THE INVENTION

Agricultural seed carts are often used for transporting bulk seed to the field. Prior art carts typically include a wheeled trailer with a large seed hopper and a conveyor to discharge seed from the hopper to a seed planter or other container. More recently, some seed carts have a conveyor which can be pivoted or moved to a reversed position for loading the seed cart. See, for example, Applicant's co-pending application, Publication No. 2012/0201631. However, prior art seed carts have limited versatility with respect to the position of the conveyor on the trailer or hopper. More particularly, while the conveyor can be pivoted or swung to various positions along the side of the trailer or hopper, the conveyor cannot be moved more than approximately 135°, and the position of the conveyor behind the cart is substantially limited.

Therefore, a primary objective of the present invention is the provision of an improved seed cart having a greater range of movement for the conveyor.

Another objective of the present invention is the provision of a seed cart trailer having a track for guided movement of the conveyor.

A further objective of the present invention is the provision of a seed cart trailer with a hopper, and a conveyor which can move approximately 180° or more relative to the hopper.

Still another objective of the present invention is the provision of a seed cart trailer wherein the conveyor can be moved between loading and unloading positions relative to the hopper.

Yet another objective of the present invention is the provision of a seed cart trailer having a conveyor which can be used for loading and unloading of external or independent containers spaced from the seed cart.

Another objective of the present invention is the provision of a seed cart having a conveyor which rolls along rails for adjustable positioning of the conveyor relative to the cart.

A further objective of the present invention is the provision of a seed cart trailer having an adjustable conveyor which is economical to manufacture, and safe and simple to use.

These and other objectives will become apparent from the following description of the invention.

### SUMMARY OF THE INVENTION

A seed cart trailer of the present invention includes a trailer with support wheels and a tongue for hitching the trailer to a tractor or other tow vehicle. A seed cart or hopper is mounted on the trailer and includes an upper inlet for loading seed into the hopper and a lower outlet for discharging seed from the hopper. A conveyor with opposite inlet and outlet ends is mounted on the trailer and is moveable between various positions to load and unload the hopper. The trailer includes a track or rails which extend along one side and along the rear or back end of the trailer. The conveyor is mounted on a carriage with rollers which roll along the track for positioning the conveyor in a desired location. A motor actuates the rollers for ease of movement of the conveyor. The conveyor is pivotally mounted on the carriage so that the inlet can be positioned beneath the hopper for discharging seed from the hopper, or the outlet can be positioned over the hopper for loading seed into the hopper. As a further alternative, the conveyor can be pivoted away from the hopper, such that both the inlet and outlet are spaced from the hopper for use in loading and unloading two separate and independent containers. Hydraulic cylinders extend between the trailer and the conveyor to control pivotal movement about horizontal and vertical axes.

### BRIEF DESCRIPTION OF THE DRAWINGS

FIG. 1 is a perspective view of the seed cart assembly according to one embodiment of the present invention.

FIGS. 1A-1G are perspective views of the trailer of the present invention showing the conveyor in various positions, with the seed container removed for clarity.

FIGS. 2A-2G are top plan views of the trailer and conveyor in various positions corresponding to the positions of FIGS. 1A-1G, respectively.

FIGS. 3A-3G are side elevation views of the trailer and conveyor, with the conveyor in positions corresponding to those shown in FIGS. 1A-1G, respectively.

FIGS. 4A-4G are rear end elevation views of the trailer and conveyor, with the conveyor in positions corresponding to those shown in FIGS. 1A-1G, respectively.

FIG. 5 is an exploded perspective view of one embodiment of the seed cart of the present invention with a single seed hopper mounted on the trailer.

FIG. 6 is an exploded perspective view of a second embodiment of the seed cart of the present invention with four seed boxes mounted on the trailer.

FIG. 7 is a perspective view showing the lock mechanism on the conveyor, according to the present invention.

FIG. 8 is an enlarged perspective view showing the carriage assembly for moving the conveyor along the track of the trailer.

FIG. 9 is a side elevation view of the conveyor carriage, according to one embodiment of the present invention.

FIG. 10 is an end view of the conveyor carriage, according to one embodiment of the present invention.

### DETAILED DESCRIPTION OF THE PREFERRED EMBODIMENTS

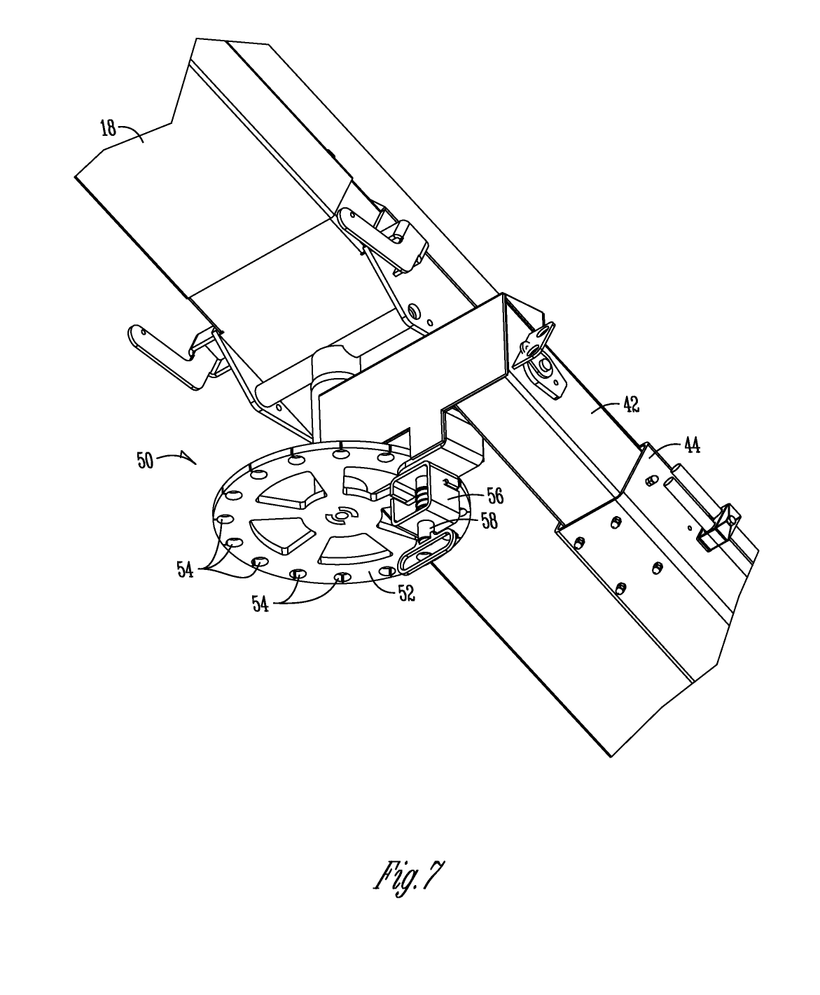

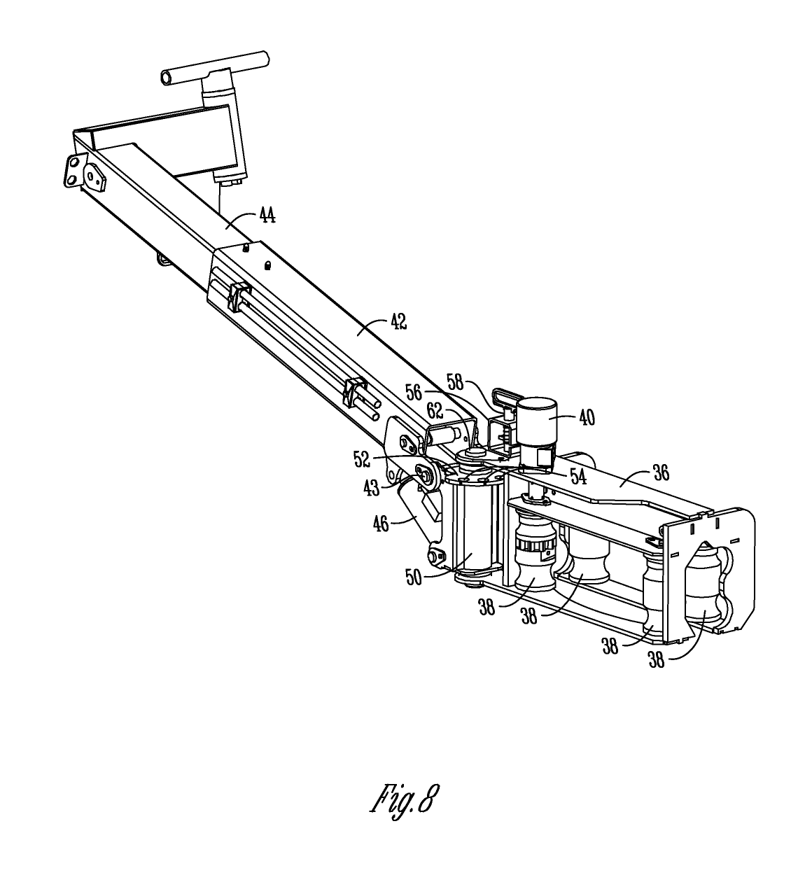

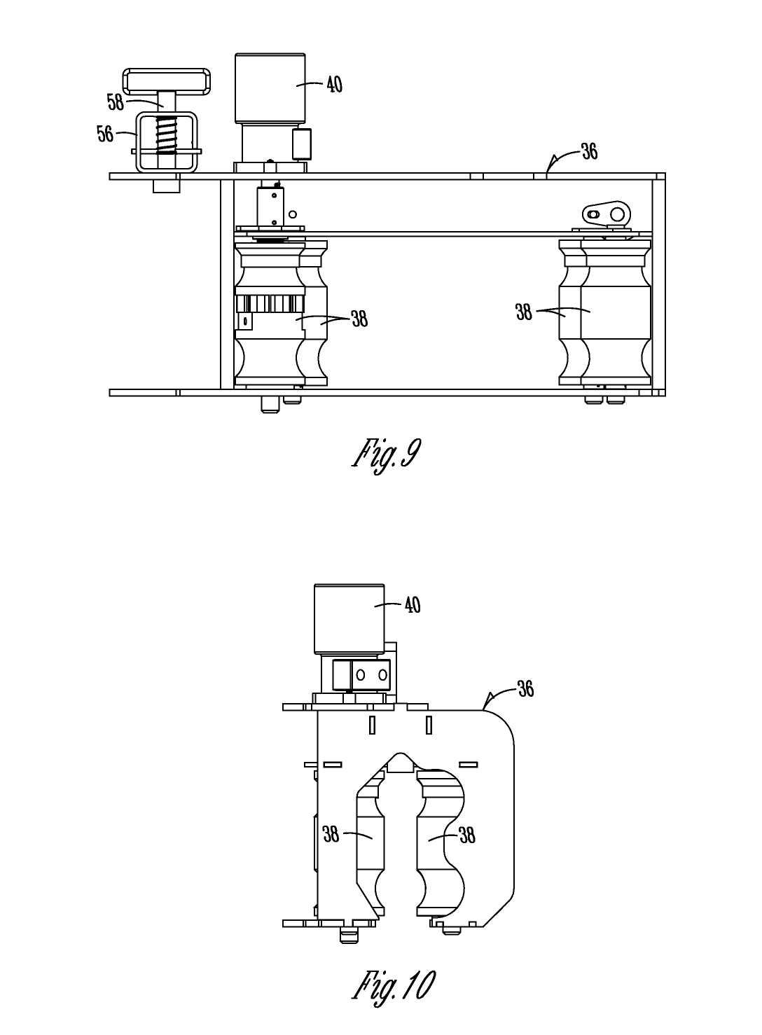

The seed cart of the present invention is generally designated by the reference numeral 10. The cart 10 includes a trailer frame 12 with a seed container, such as a hopper 14, mounted on the trailer 12. The hopper 14 is supported by a frame 16, which effectively cantilevers the hopper 14 over the trailer 12 from the right side of the trailer 12 toward the left side of the trailer 12. As an alternative to the hopper 14, one or more seed boxes 15, as are known in the art, can be mounted on the trailer 12 via a frame 17, as seen in FIG. 6. The cart 10 further includes a conveyor 18 which is moveable to various positions relative to the trailer 12 and the hopper 14, as described in further detail below. The cart 10 also includes a plurality of wheels 20 and a gooseneck hitch 22 or alternatively a tongue hitch, for hitching the cart 10 to a tractor or other tow vehicle.

The hopper 14 includes an upper inlet 24 and a lower outlet 26. The hopper 14 has a sloped floor so that seed in the hopper 14 flows by gravity to the outlet 26. A conventional gate (not shown) is provided on the hopper 14 adjacent the outlet 26 and moves between open and closed positions so as to control discharge of seed from the hopper 14.

The conveyor 18 includes an inlet 28 and an outlet 30. The conveyer 18 includes a belt and a belt drive system for transporting seed from the inlet 28 to the outlet 30. Preferably, the belt and belt drive system are the same or similar to that described in Applicant's co-pending application Ser. No. 13/106,168, now U.S. Pat. No. 8,292,065, issued on Oct. 23, 2012, entitled CROSS CLEATED CONVEYOR BELT FOR A TUBULAR CONVEYOR and filed on May 12, 2011 which is incorporated herein by reference. Alternatively, other belts and drive systems, as known in the art, may be utilized.

The trailer 12 has a track 32 comprised of one or more rails 34 which extend along the left side of the trailer 12 and along the rear or back end of the trailer 12. The rails 34 are curved at the left rear corner of the trailer 12, as best seen in 1B and 2B. The conveyor 18 is mounted upon a carriage 36 which runs along the rails 34 of the track 32. More particularly, the carriage 36 includes a plurality of rollers 38 which roll along the rails 34 to guide movement of the conveyor 18 on the track 32. As seen in FIG. 8, in the preferred embodiment, the rollers are spaced on opposite sides of the rails 34 such that the rails are sandwiched between the rollers. Other guide systems are within the scope of the invention, such as a slotted track with ball bearing rollers, similar to a drawer glide, or a tongue and groove structure. An electric or hydraulic motor 40 is provided on the carriage 36 and is operably connected to at least one of the rollers 38 to drive the roller for movement of the conveyor 18 along the track 32. Alternatively, the motor 40 can be eliminated and the conveyor carriage 36 can be moved manually along the track 32. Thus, the conveyor 18 can be selectively positioned anywhere along the left side or rear end of the trailer 12 by the motorized carriage 36.

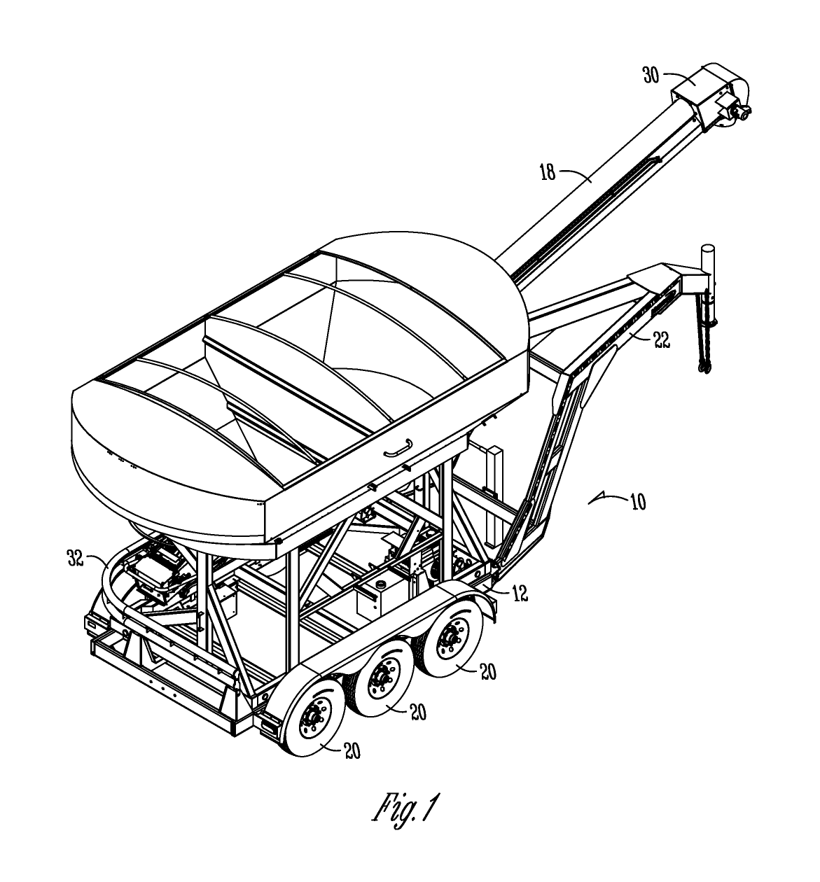

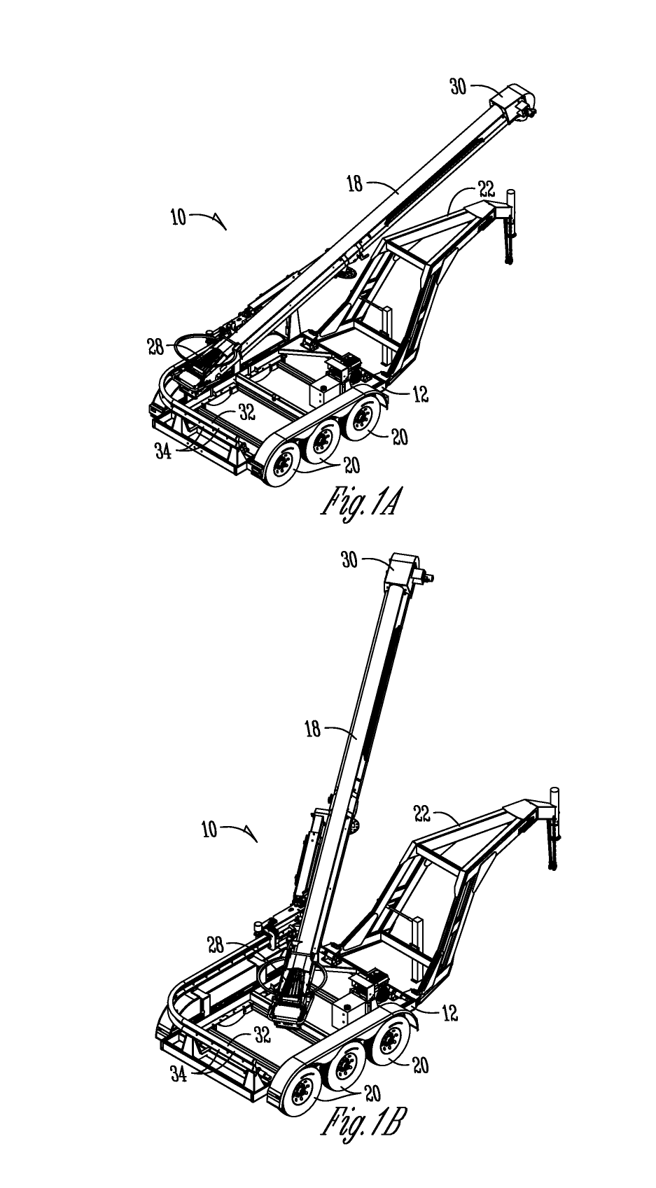

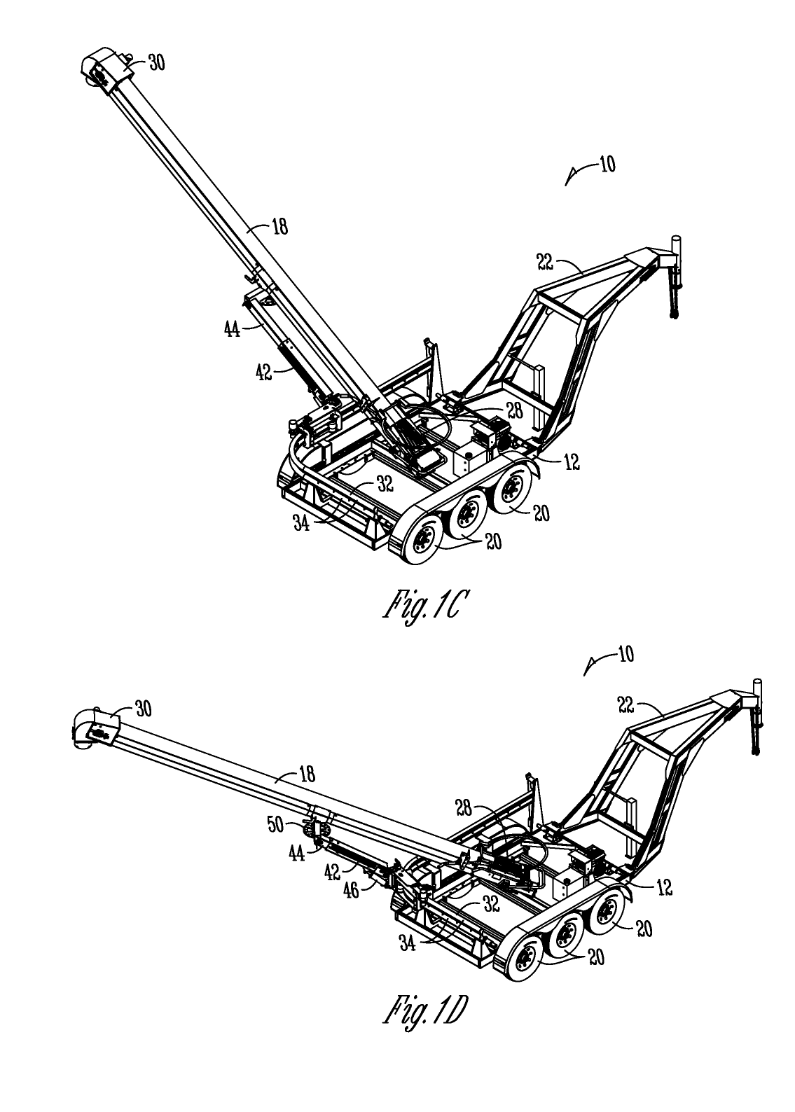

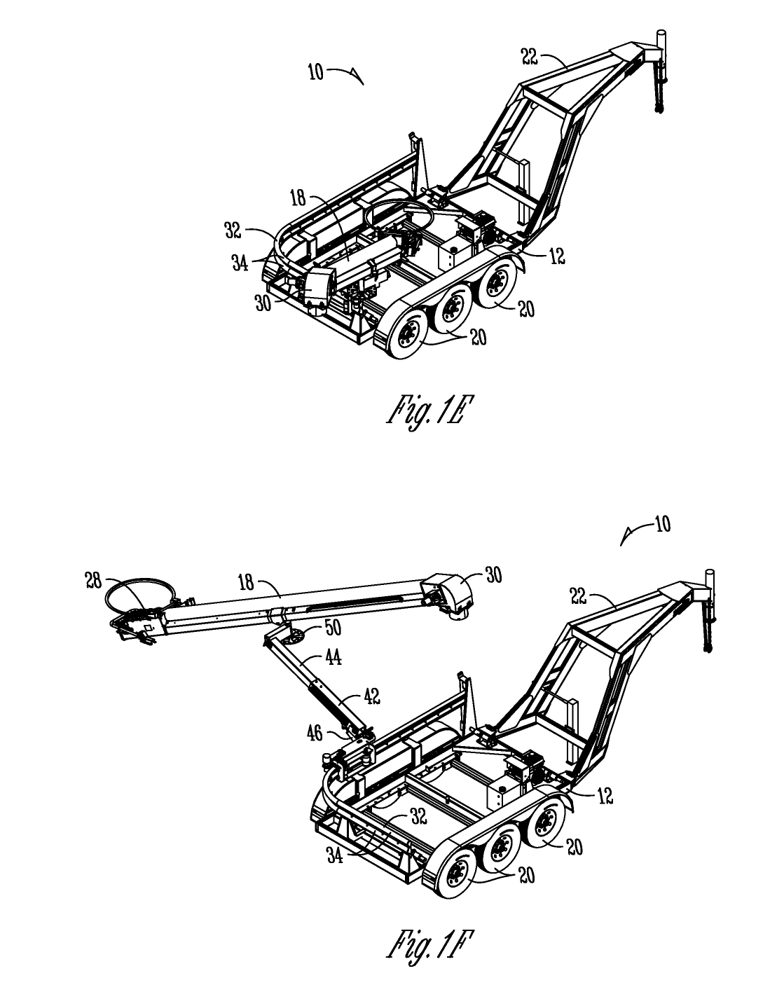

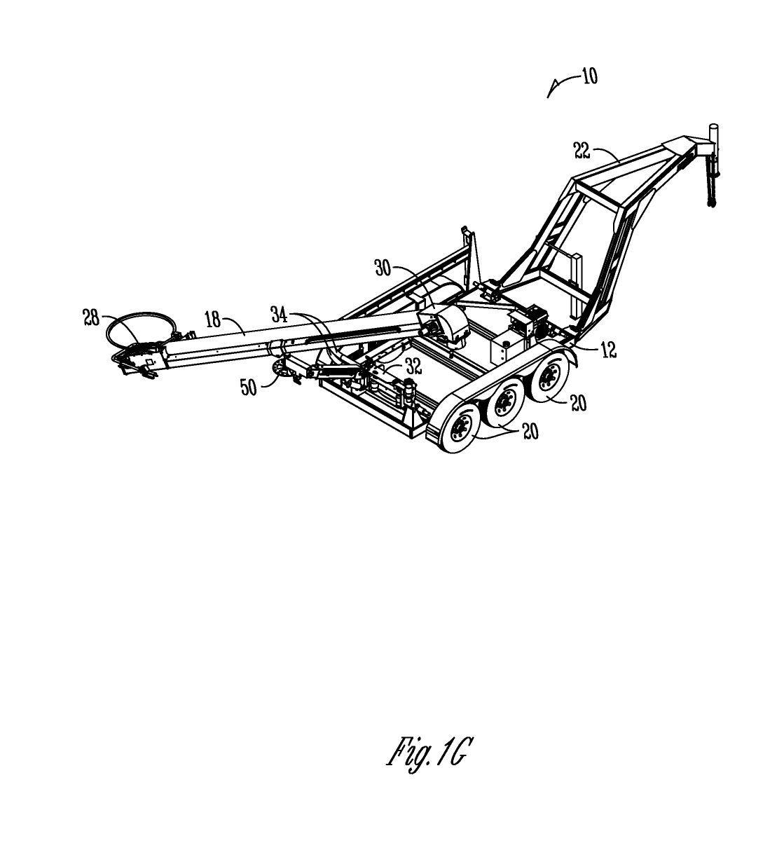

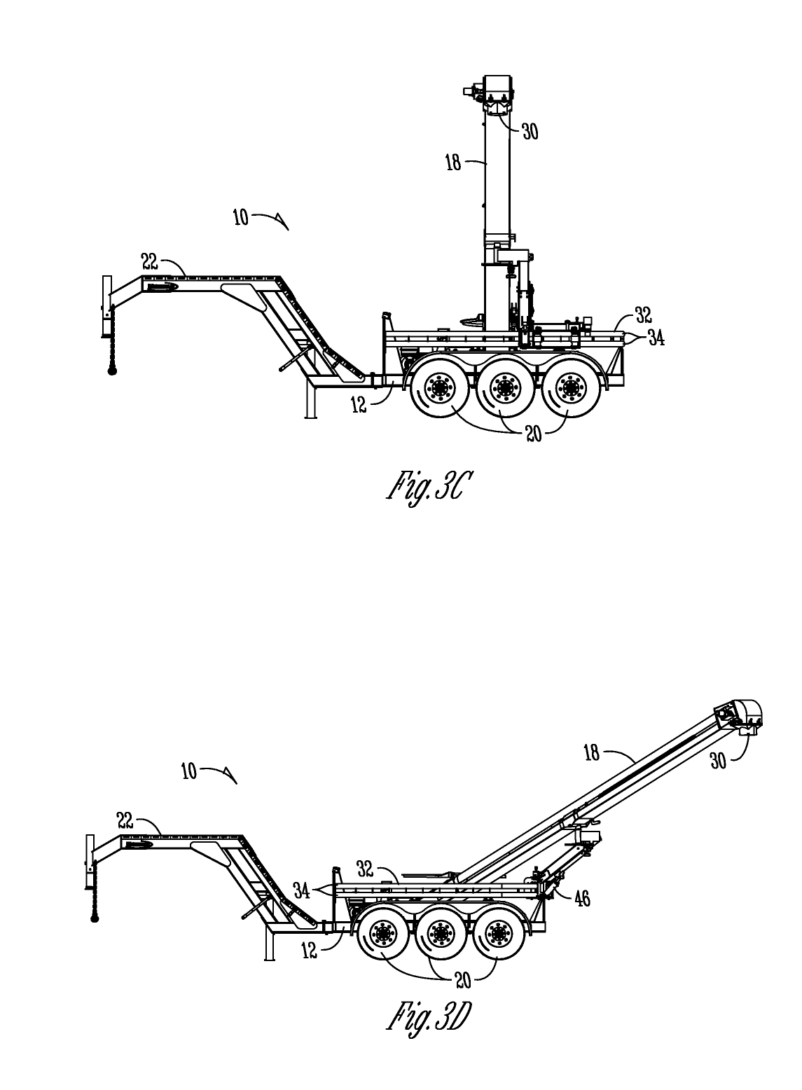

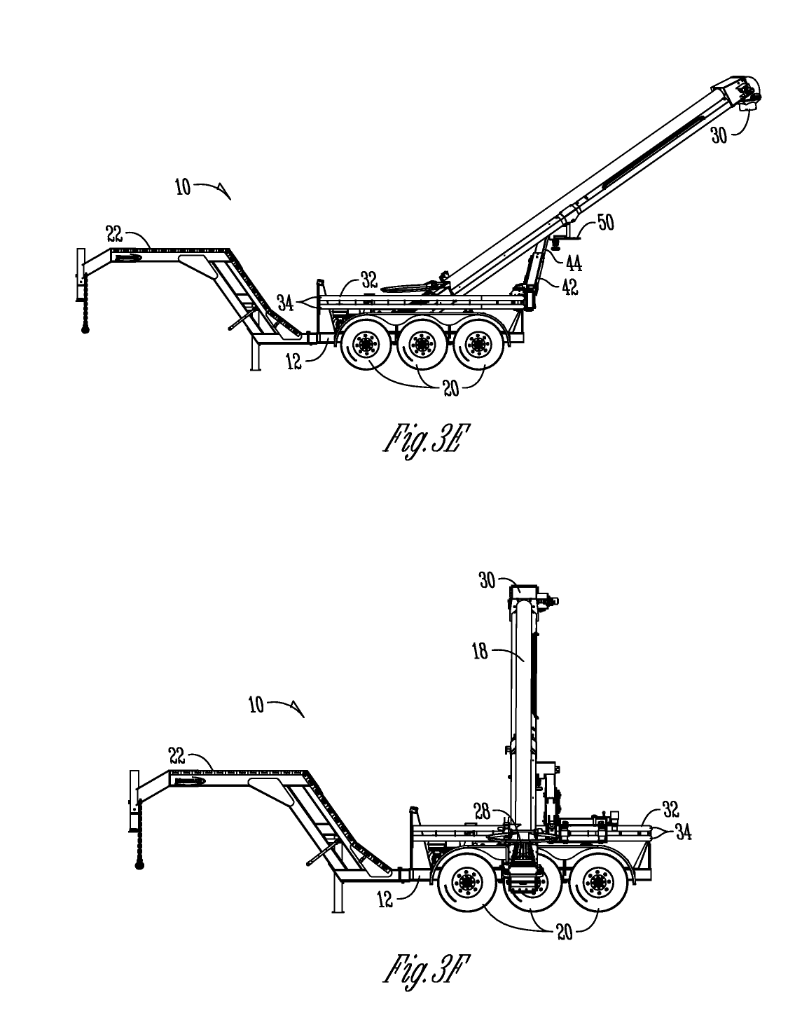

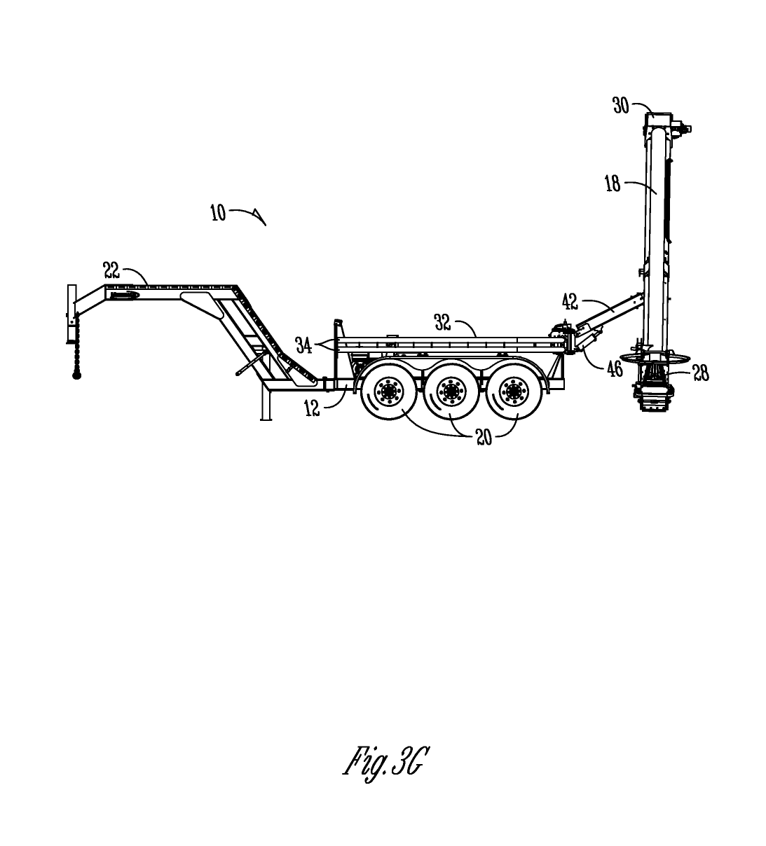

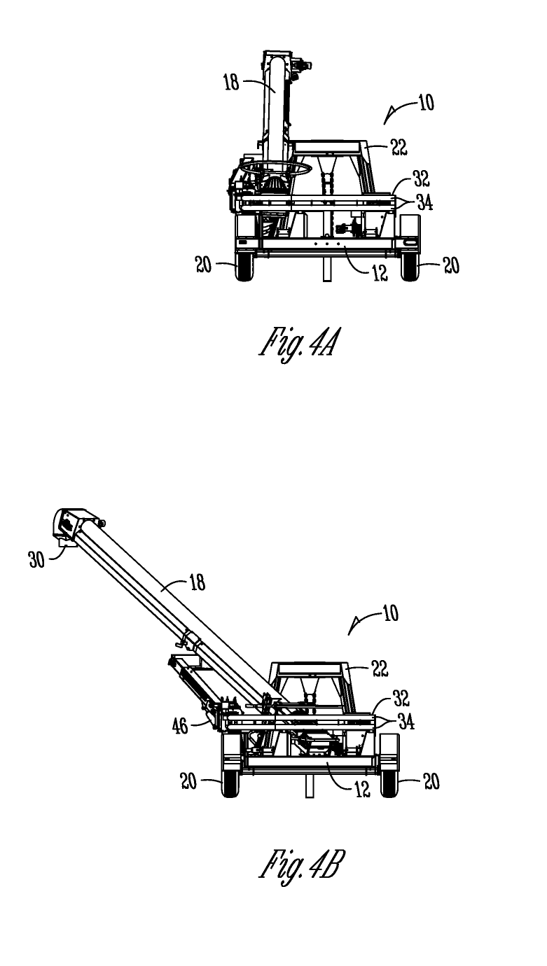

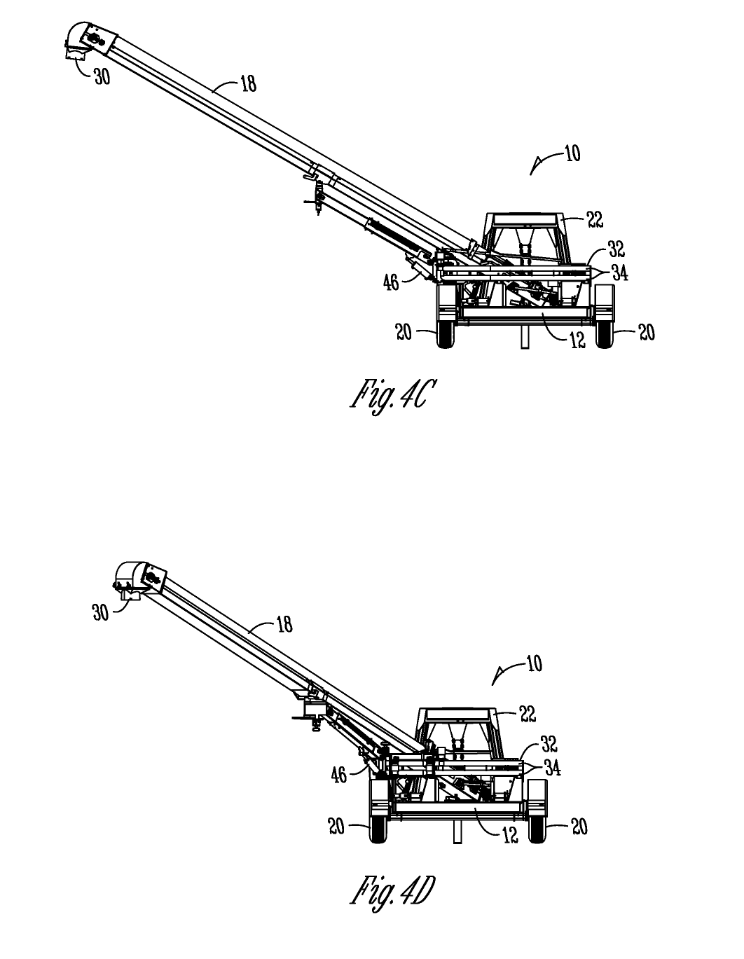

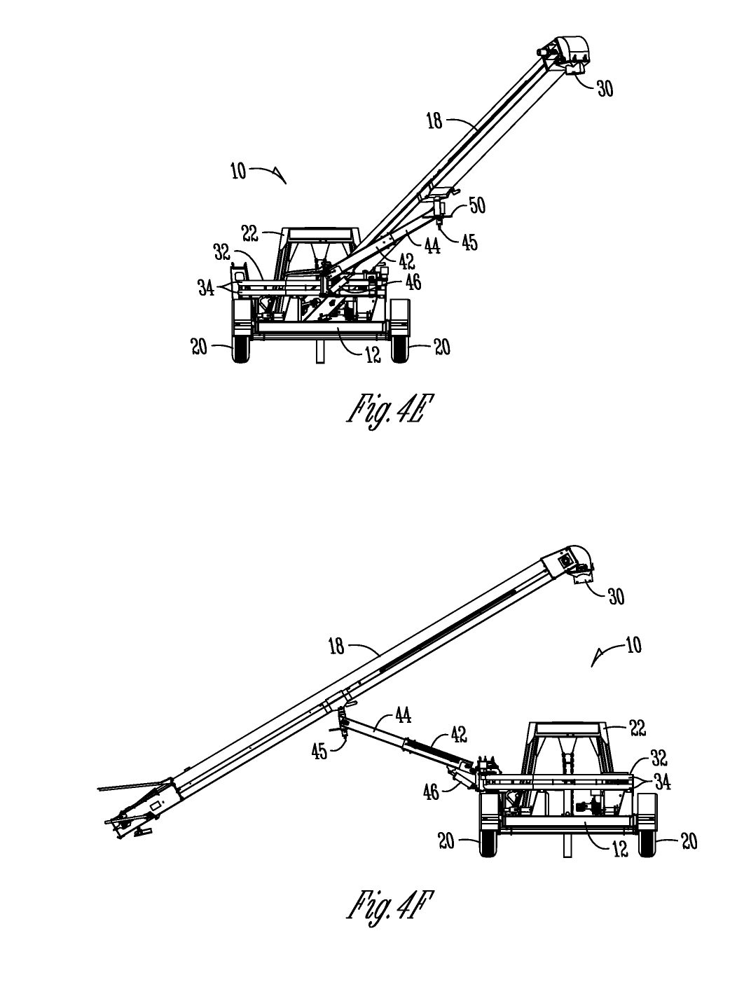

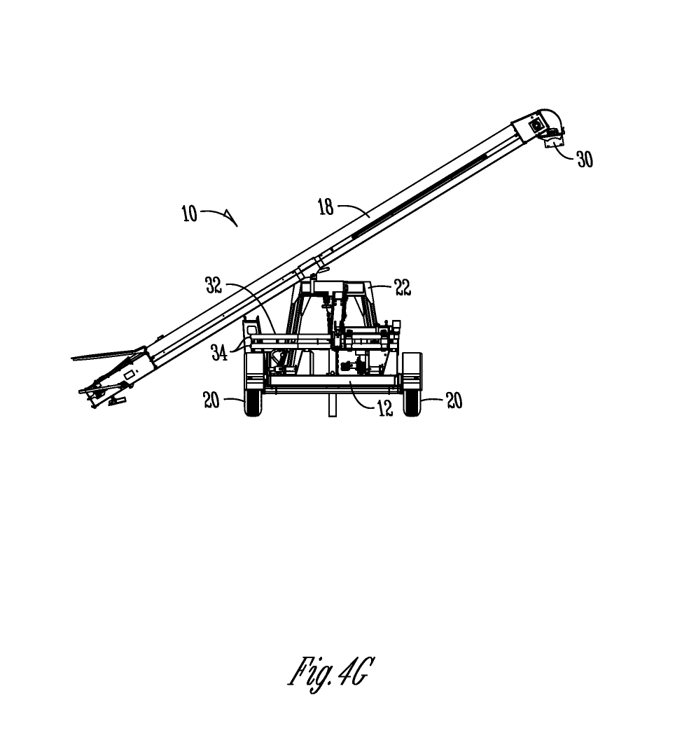

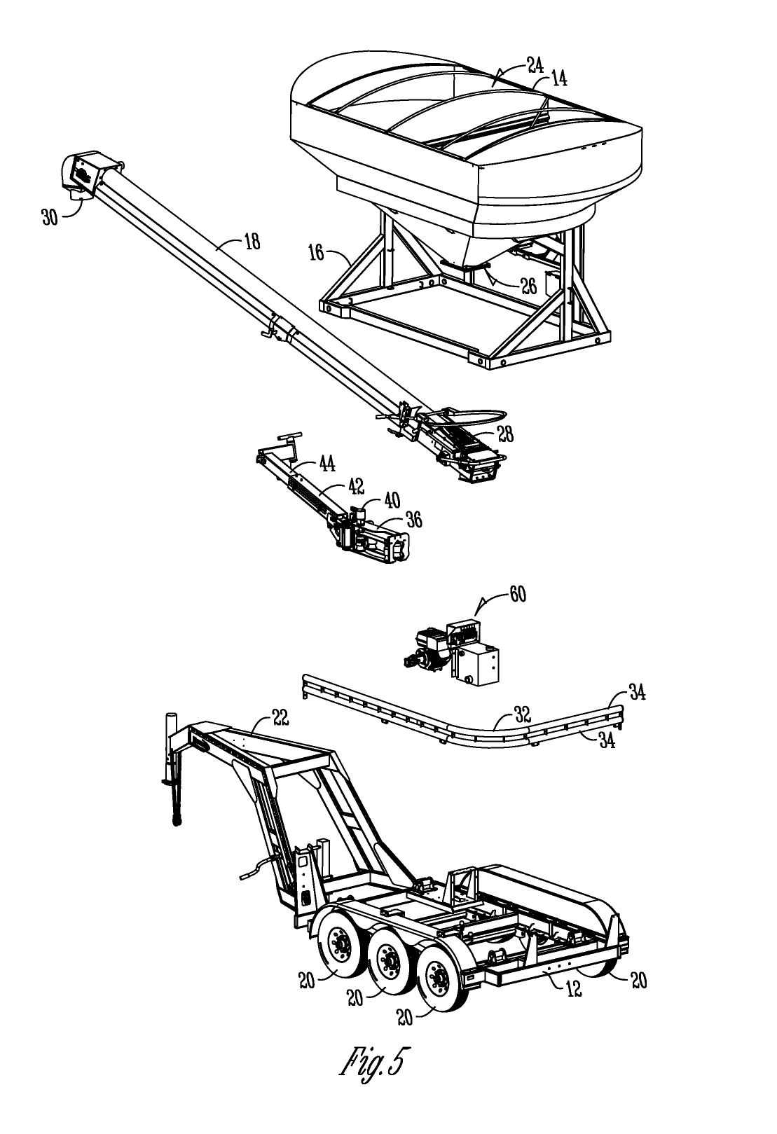

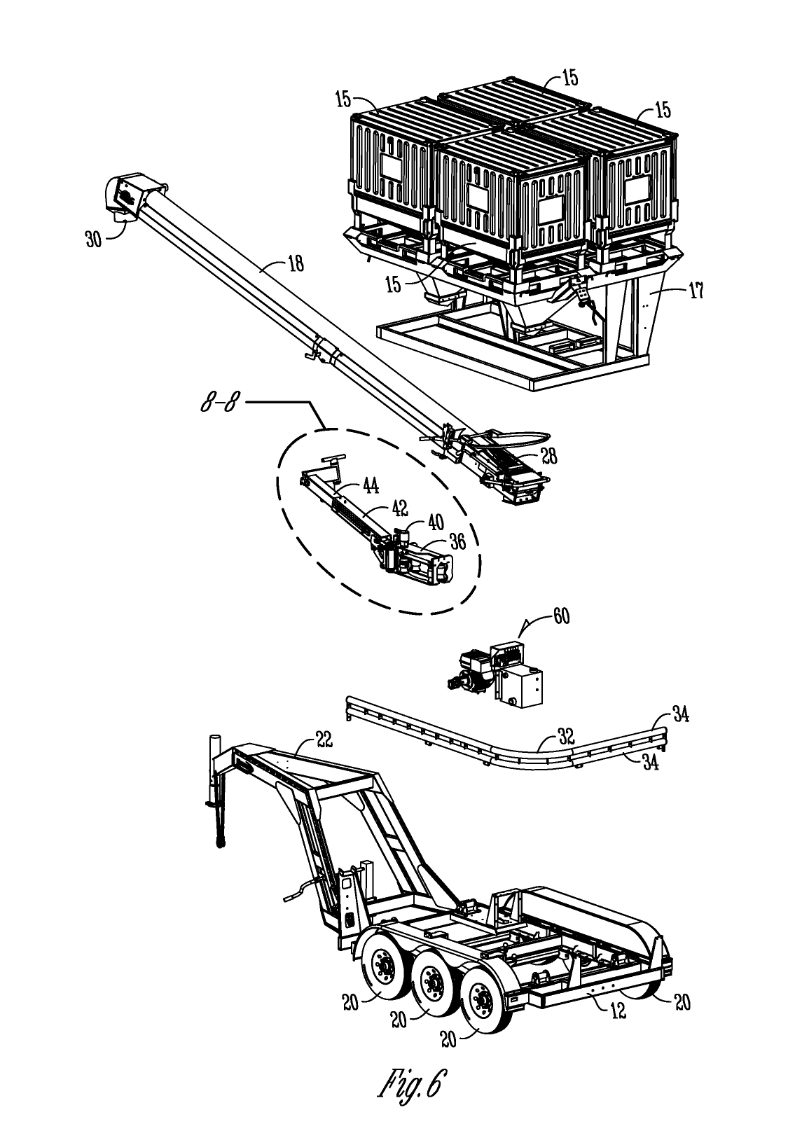

For example, the carriage 36 can be positioned on the side of the trailer 12 adjacent the front end of the track 32 in a lowered transport position, as shown in FIGS. 1A, 2A, 3A and 4A; or the conveyor 18 can be raised to a first use position, as seen in FIGS. 1B, 2B, 3B, and 4B; or the carriage 36 can be positioned on the side of the trailer 12 adjacent the rear wheel of the trailer 12, as seen in FIGS. 1C, 2C, 3C, and 4C; or the carriage 36 can be positioned adjacent the left rear end or corner of the trailer 12, as seen in FIGS. 1D, 2D, 3D, and 4D; or the carriage 36 can be positioned at the right rear corner of the trailer 12, as seen in FIGS. 1E, 2E, 3E, and 4E.

The cart 10 includes multiple hydraulic cylinders to further control the movement of the conveyor 18. A first cylinder 42 with an extendable and retractable arm 40 adjusts the position of the conveyor outlet 30. The height of the conveyor outlet 30 is adjusted by a second cylinder 46, which has a lower end connected to the carriage 36 and an upper end connected to the first cylinder 42 for pivotal movement of the conveyor 18 about a substantially horizontal axis 43. A pivot connection 45 is provided between the conveyor 18 and the arm 44 of the cylinder 42. This connection has a substantially vertically oriented pivot axis, such that the conveyor 18 can pivot about the point 45 whereby the conveyor inlet 28 of the conveyor 18 can be moved beneath the hopper outlet 26, as shown in FIGS. 1B-4B, 1C-4C, 1D-4D, and 1E-4E, or the inlet 28 can be swing away from the hopper 14 and that the conveyor outlet 30 is positioned over the hopper inlet 24, as shown in FIGS. 1F-4F. A hydraulic control system 60 including a hydraulic motor, is mounted on the trailer 12 and is operatively connected to the cylinders 42, 46.

The conveyor 18 can also be moved to the position shown in FIGS. 1G-4G wherein both the conveyor inlet 28 and conveyor outlet 30 are spaced apart from the hopper 14. In this position, the conveyor 18 can be used to load and unload two separate or independent containers.

A lock assembly or mechanism 50 is provided on the carriage 36, as best shown in FIG. 8. The lock mechanism 50 allows the conveyor 18 10 be rotated about a vertical axis and then locked in the selected position. The lock mechanism 50 includes a round plate 52 with a plurality of holes 54 extending 180° around the plate. A bracket 56 supports a spring biased pin 58 which can be selectively extended and retracted to and from any of the holes 54 to lock and unlock the conveyor 18 against or for pivotal movement about a pin 62 extending through the carriage 36.

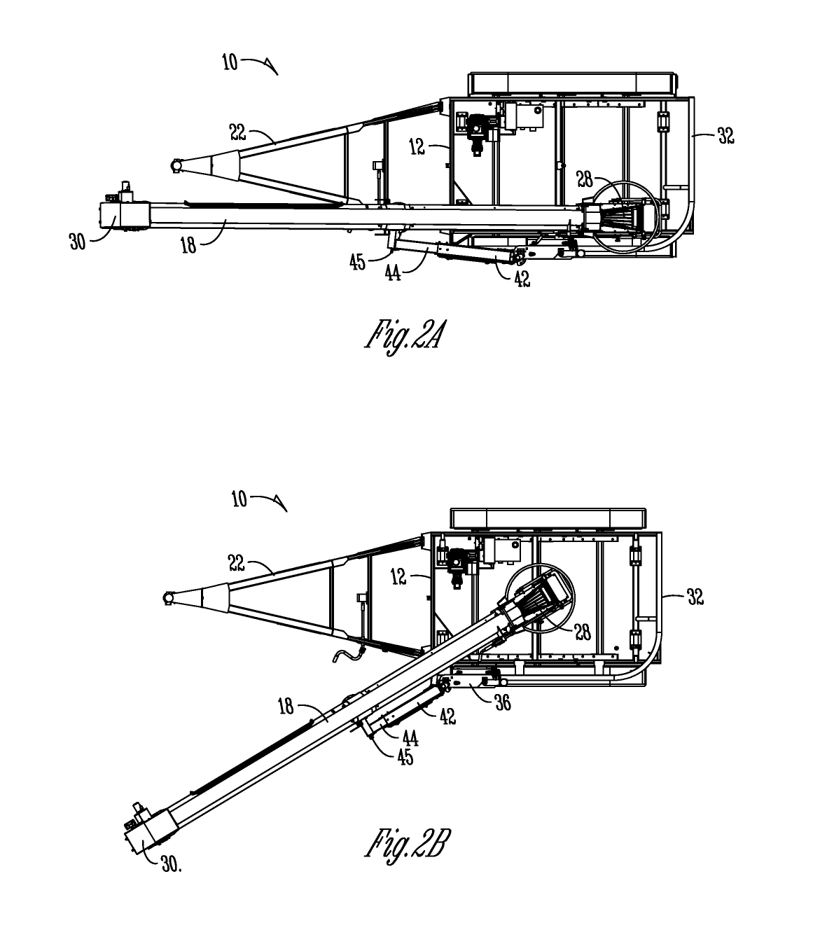

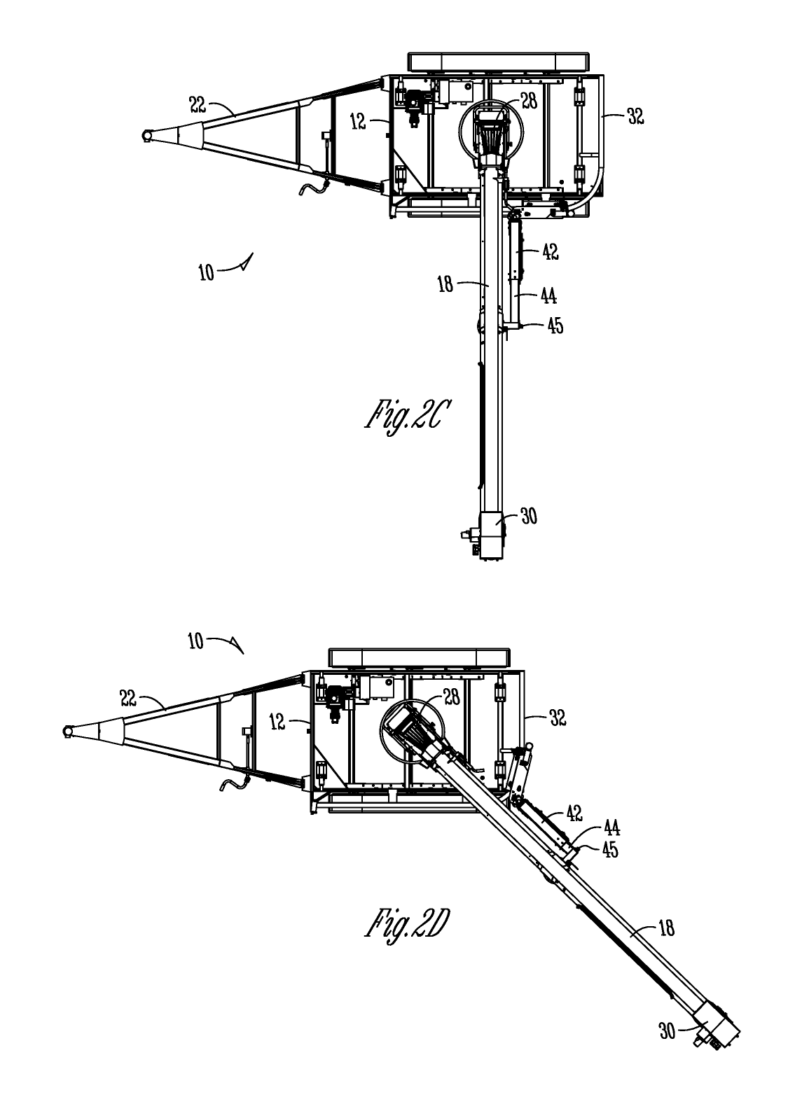

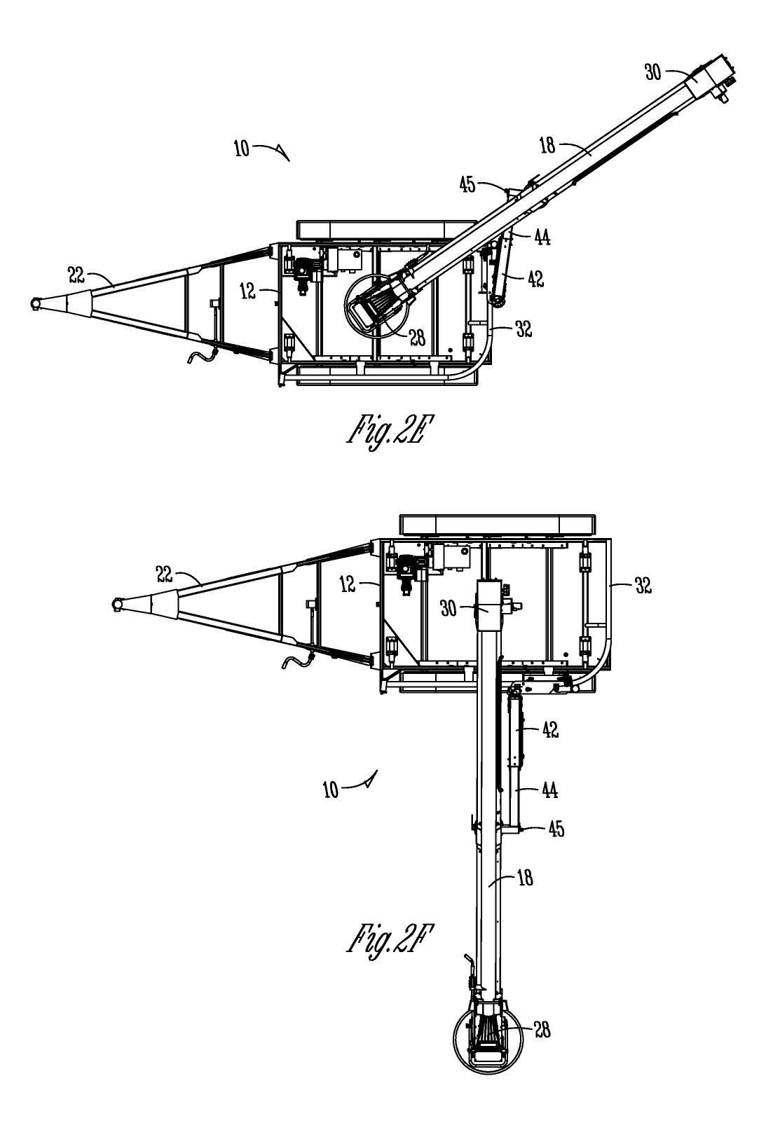

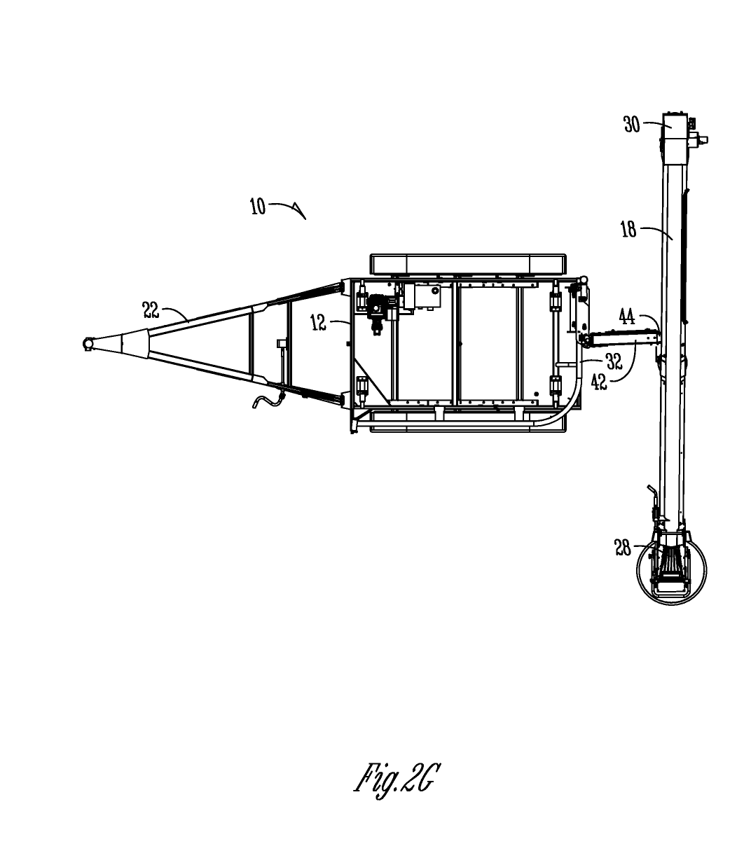

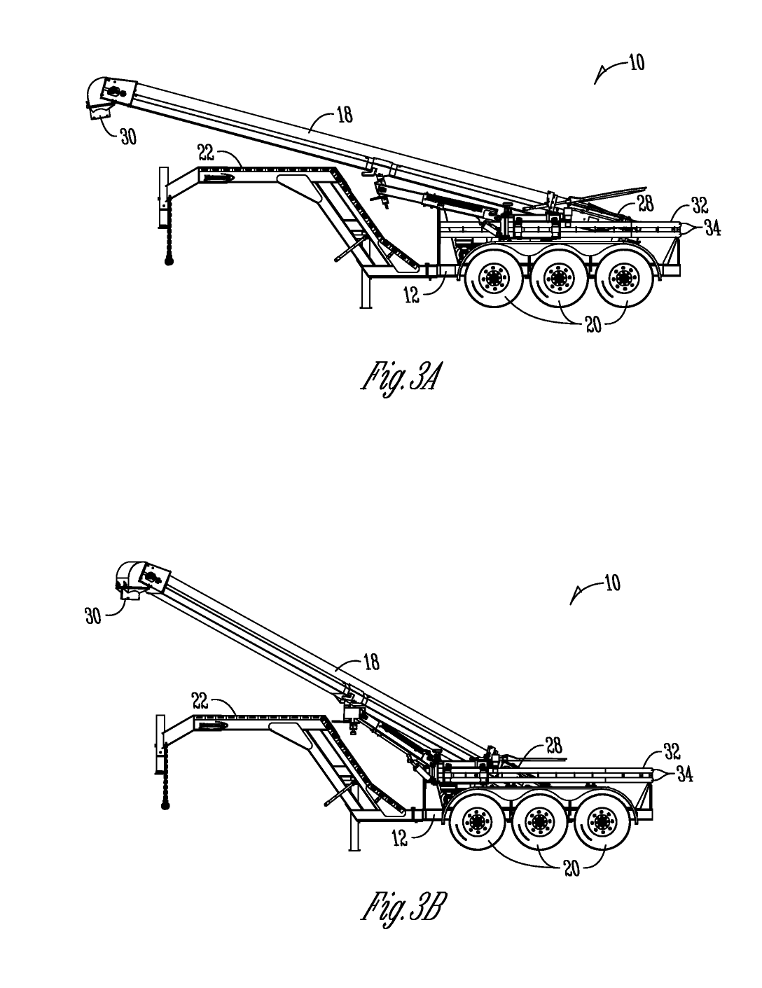

In the preferred embodiment, the rotational movement of the conveyor about the pivot pin 62 is achieved manually. However, such rotation can also be achieved via a hydraulic cylinder assembly which can push and/or pull the conveyor through an angular range, as best seen in FIGS. 2A, 2B, 2C, 2D and 2E.

A second lock assembly 50 may be optionally be provided on the conveyor 18 adjacent the pivot axis 45, as seen in FIG. 5. The second lock 50 allows the angular orientation of the conveyor relative to a vertical axis 45 to be selectively set.

The legs 16 of the hopper 14 provide an unobstructed path for movement of the conveyor 18 from the forwardly extending transport position shown in FIG. 2A to the rearwardly extending operational position shown in FIG. 2E. Thus, the conveyor 18 can move fully along the left side and rear end of the trailer 12, without obstruction by the hopper legs or frame 16. The track 32 and pivotal movement of the conveyor 18 about the vertical axis by the cylinders 48 allow the conveyor outlet 30 to move at least 180° from the position shown in FIG. 2A to the position shown in FIG. 2E.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A seed cart trailer, comprising:
a wheeled frame with a tongue for connecting to a vehicle hitch, and having opposite sides, a front end, and a back end;
a seed container mounted on the frame;
a conveyor assembly having opposite inlet and outlet ends, and being mounted for pivotal movement greater than 180° about the inlet end.

2-4. (canceled)

5. The trailer of claim 1 wherein the conveyor is pivotal about a substantially vertical axis between the inlet and outlet ends.

6. The trailer of claim 5 further comprising a lock adjacent the vertical axis to fix the conveyor in a selected pivotal position.

7. The trailer of claim 6 wherein the lock includes a plate with a plurality of holes and a pin selectively insertable into one of the holes.

8. The trailer of claim 1 wherein the conveyor is pivotal about a substantially horizontal axis so that the height of the discharge end is adjustable.

9. The trailer of claim 1 wherein the conveyor is pivotal about a substantially vertical axis so as to swing the outlet end to a desired position relative to the frame.

10. The trailer of claim 1 wherein the conveyor is adjustable between a first unloading position wherein the inlet is beneath the seed container on the frame, a second loading position wherein the outlet is above the seed container on the frame, and a third position wherein the inlet and outlet a spaced outwardly from the seed container.

11. A conveyor assembly, comprising:
a conveyor with an inlet and an outlet;
a frame to support the conveyor and having a front end, a back end, and opposite sides;
the conveyor being adjustable relative to the frame between a first position with the inlet located adjacent the frame and the outlet spaced laterally from the frame, a second position with the outlet located over the frame and the inlet spaced from the frame, and a third position with the inlet and outlet both spaced from the frame; and
wherein the conveyor can be located on one side of the frame in all three positions and can be located behind the frame in all three positions.

12-17. (canceled)

18. The conveyor assembly of claim 11 further comprising a plurality of hydraulic cylinders to control movement of the conveyor.

19. The conveyor assembly of claim 11 further comprising a lock on the conveyor to releasably fix the conveyor in a selected position.

20. The conveyor assembly of claim 11 further comprising a seed container mounted on the frame so as to cantilever from one side of the frame toward another side of the frame.

21. The trailer of claim 2 wherein the conveyor is pivotal approximately 135° about the inlet end.

22. The conveyor assembly of claim 11 wherein the conveyor is mounted on a seed cart trailer.

23. The conveyor assembly of claim 22 wherein the frame is part of the trailer.

24. The conveyor assembly of claim 11 wherein the conveyor has opposite inlet and outlet ends, and is pivotal more than 180°.

25. The conveyor assembly of claim 24 wherein the conveyor is pivotal approximately 135° about the inlet end.

26. The conveyor assembly of claim 24 wherein the conveyor is pivotal about a substantially vertical axis between the inlet and outlet ends.

27. The conveyor assembly of claim 24 wherein the conveyor is pivotal about a substantially horizontal axis so that the height of the discharge end is adjustable.
